(19) United States
(12) Patent Application Publication
(10) Pub. No.: US 2007/0181560 A1
(43) Pub. Date: Aug. 9, 2007

(54) PERSONAL HEATING DEVICE

(76) Inventor: David Glen Baker, Carleton, MI (US)

Correspondence Address: CARGILL & ASSOCIATES, P.L.L.C., 56 MACOMB PLACE, MT. CLEMENS, MI, 48043, US

(21) Appl. No.: 11/672,914

(22) Filed: Feb. 8, 2007

Related U.S. Application Data
(60) Provisional application No. 60/765,868, filed on Feb. 8, 2006.

(51) Int. Cl. H05B 1/02

(52) U.S. Cl. 219/505

(57) ABSTRACT

A portable personal heating device including a heater and an optional heat suit is disclosed. The heater is adapted to be used with a removable heat source including a base to receive the heat source and a heat stack attached to the base. The heat suit is preferably a camouflaged poncho, which encompasses a user's body and the heater to keep warm and enhances the blending and camouflaging of the user relative to an environment. The personal heating device is simple, portable, lightweight and effective for outdoor recreations in winter.

### CROSS REFERENCES TO RELATED APPLICATIONS

This application claims the benefit under 35 U.S.C. 119(e) of U.S. Provisional Application No. 60/765,868 filed on Feb. 8, 2006, which is incorporated herein in its entirety.

### BACKGROUND OF THE INVENTION

1. Field of the Invention

The present invention relates to a personal heating device. More particularly, the invention relates to a portable heating device including a heater and a heat suit for use in an outdoor environment in winter.

2. Description of the Prior Art

Many outdoor activities which include ice fishing, hunting and sporting events are held during the winter months. To facilitate the cold weather people must dress accordingly to keep warm. It is found, even though people are dressed accordingly for the cool weather, spending long periods of time outdoors in the cold will cause a person to become cold or injured.

Conventional heating devices are well known in the art. Certain of these devices are intended to serve two or more purposes, for instance, by providing both cooking and seating surfaces, or for heating both tents and individual users. As a result, many of them are not particularly well-suited to the singular purpose of effectively warming a person with such a device. It likewise appears that very few, if any, of such devices are widely commercially available.

One example of a commercially available personal heating device is a heat seat, which is a seat arranged to contain a heating element, specifically a heating canister, which heats the container allowing a person to sit on a heated seat.

A number of disadvantages are associated with devices such as those described above. Many of the devices, for instance, involve the transfer of heat to the sitting surface itself, thereby warming the person, at least in part, by providing for direct contact between the user's body and a heated surface. Because the heating canister is located directly below the seat, it would cause the heat to become excessive thereon not providing a comfortable temperature for the seat. In many of these, and other, devices, the user's own body may also serve to block or obstruct the flow of heated air.

Direct contact between the body and a heated surface requires that the seating surface be sufficiently covered, as by intermediate layers, or that its temperature be kept sufficiently low to avoid discomfort, or even burning of the user. Devices and seating positions that use the body to block the flow of warm air can raise similar concerns.

Many other devices can be cumbersome to carry, or to assemble and/or use, particularly in situations where the user must also carry assorted gear and where the user may be wearing cumbersome clothing.

It would be of a great advantage to the outdoor activity goers if there was provided a simple, portable, and effective personal heating device that overcomes the problems such as those described above.

### SUMMARY OF THE INVENTION

In accordance with the above-noted advantages and desires of the industry, the present invention provides a personal heating device. This invention includes a heater and heat suit that may be used together. This overcomes many aforementioned problems with the prior art because it is simple, portable, inexpensive and effective.

One specific preferred embodiment of the heater has certain features including a base having a holding area enclosed by at least one peripheral wall for receiving a removable heat source and a heat stack including a lining, said heat stack being removably attached to the at least one peripheral wall of the base.

Another preferred embodiment of the heater has other features including a base having a holding area surrounded by at least one peripheral wall for receiving a removable heat source and a mounting flange attached to the bottom of the holding area, and a heat stack removably attached to the at least one peripheral wall of the base.

A third preferred embodiment of the personal heating device of the present invention includes a heater and a complementary heat suit. The heater includes a base container for receiving a removable heat source and a heat stack removably attached to the base container. The heat suit is preferred a floor length camouflaged poncho, which encompasses a user's body and the heater to keep warm, and enhances the blending and camouflaging of the user relative to an environment. Preferably, the heater is placed on the ground between the legs of the hunter or fisherman. A seat may be placed behind the heater. The long poncho heat suit is draped over the hunter as well as the heater on the ground, almost as if the hunter was straddling the heater. The hunter will then sit down on his seat behind him, so that the heater will be between the legs of the seated hunter. The poncho will drape from the neck of the hunter down to his knees, creating a diagonal from his neck to his knees. This “tented” area is where the heat from the heater will be trapped under the poncho, keeping the hunter warm. A small flame from the heater is sufficient to keep a hunter or fisherman warm in below zero temperatures without any of his body parts or clothing getting near a flame.

This technique of the present invention of the personal heating device may not only be used in various outdoor activities, such as hunting, ice fishing, football games and ice hockey watching, but also can be extended to some large indoor events where the heating system is not sufficient.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and shall be taken in conjunction with the accompanying drawings, in which like parts are given the same reference numerals, and wherein;

FIG. 1 is a perspective view of a heater of the personal heating device made in accordance with the present invention;

FIG. 2 illustrates an exploded perspective view of the personal heating device of FIG. 1; and

FIG. 3 is a front view of a heat suit of the personal heating device of the present invention.

### DETAILED DESCRIPTION OF THE INVENTION

While the present invention may comprise embodiments which may take various forms, there is shown in the drawings and will hereinafter be described presently preferred embodiments with the understanding that the present disclosure is to be considered an exemplification of the invention and is not intended to limit the invention to the specific embodiment, size or shape illustrated.

It should be further understood that the title of this section of this specification, namely, “Detailed Description Of The Invention”, relates to a requirement of the United States Patent and Trademark Office, and does not imply, nor should be inferred to limit the subject matter disclosed herein.

The present invention discloses a personal heating device including a heater and an optional heat suit for use in an outdoor environment. The personal heating device is portable, lightweight, simple and easy to use to keep warm in winter. The heater may be used without the aid of the heat suit. It is preferred, however, that the heat suit is used along with the heater, especially for winter outdoor activities, such as ice-fishing and hunting.

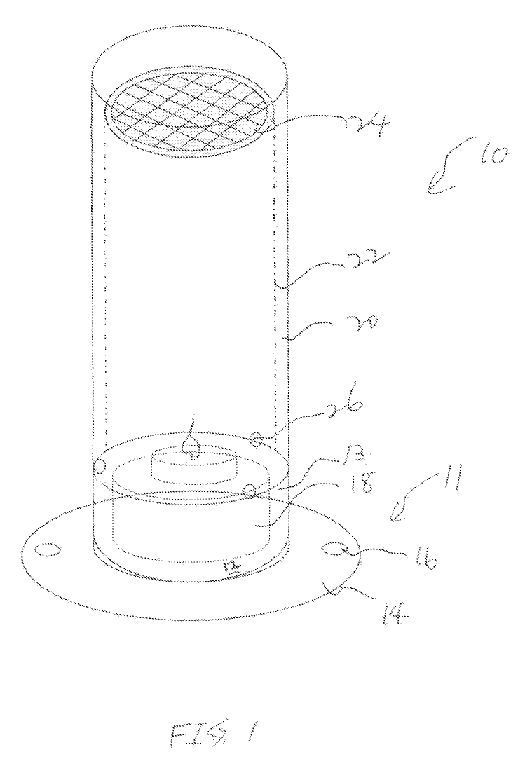

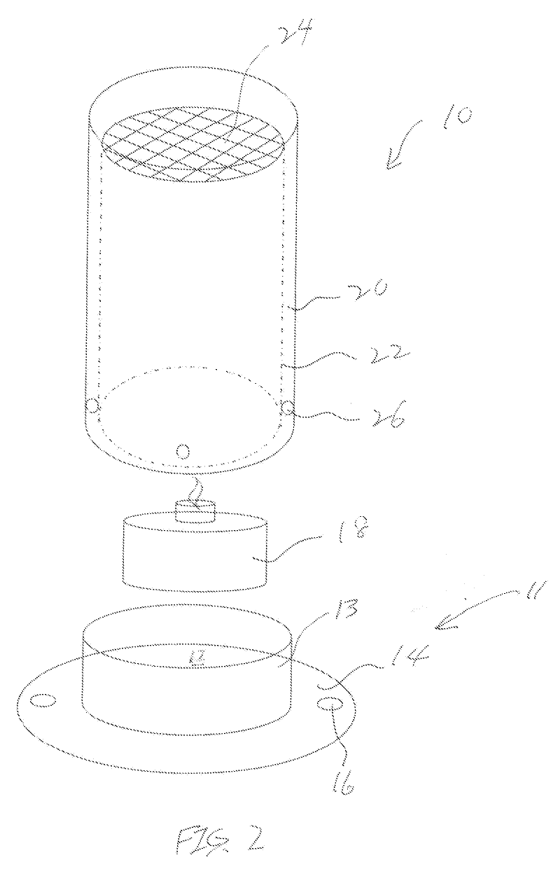

Referring now to the drawings in detail, FIG. 1 and FIG. 2 show a heater, generally indicated by the numeral 10, of the personal heating device of the present invention. Heater 10 includes a base, generally indicated by the numeral 11, adapted for receiving a removable heat source 18 and a heat stack 20 attached to the base 11. Base 11 preferably includes a holding area 12 surrounded by a ring-shaped peripheral wall 13 for receiving the removable heat source 18. Although an appropriately sized component is usable, a conventional toilet bowl gasket may be adapted as the base, because it has the size and shape that may be preferred for the present invention.

A mounting flange 14 may be attached to the bottom of the holding area 12 for mounting purposes, so that the base of the heater may be staked into the ground or ice, or fastened to a platform base if used above the ground. At least one hole 16 is located in a suitable location on the mounting flange 14 for use with a conventional fastener. Any conventional fasteners for securing, fastening or joining known to those skilled in the art may be used, which includes hook and loop strips, cable ties, screws, glue, bolts, clamps, clips, rivets, hooks, clasps, latches, nuts, pins, pegs, slots, and slits, among others.

The heater may be removably secured based on different sports, activities or preferences. For example, while in a hunting activity, some hunters may prefer keeping the heater on the ground and the preferred fastener is therefore, a stake. Stakes are common, inexpensive and easy to apply onto the ground. On the other hand, other hunters may prefer waiting on a tree stand, which may be made of nests or meshes. In this application, a cable tie may be a preferred fastener.

Heat stack 20 is preferably sized and shaped to friction-fit over peripheral wall 13, so that it may be removably attached to the base 11. As shown in FIG. 1 and FIG. 2, as an example, while the holding area 12 is ring-shaped, preferably the heat stack is tubular. Many conventional means can be adapted as the heat stack, such as drainpipes. Preferably, the heat stack is made of polyvinyl chloride (PVC) plastic and is about 4″ in diameter and 18″ in length.

Heat stack 20 may include lining 22, a screen 24 and at least one heat source securement 26. Lining 22 is preferably made of metals or alloys for their high melting points. Preferred linings may be sheets of steel or aluminum foil. Lining 22 enhances the heat transfer rate, as well as increases the efficiency of the heater.

Screen 24 may be an extra safety device to avoid direct physical contact with the flame, if it may ever happen. The screen 24 may be secured in any suitable location inside or on the top of the heat stack. Preferably, screen 24 may be located in the internal, top portion of the heat stack 20. Specifically, lining 22 may be folded into creases in its top portion, so that the creases may further support the screen 24 from falling off. Screen 24 is preferably installed about 2″ to 3″ down from the heat stack top edge. The space between the heat stack top edge and the screen provides extra utilities. For example, the user of the heater may use the screen as a cup warmer, a grill or any other application requiring heat.

Heat source securement 26 may be selected from any suitable conventional means, as long as it can secure and keep the removable heat source 18 in place. An example of a heat source securement may be at least one 1″ long bolt penetrating the heat stack from outside in. As a result, the horizontally sustained bolt may be able to stop the vertical movement of the heat source and therefore, holds the heat source in place.

To further increase the ventilation, various modifications, which are also within the scope of the present invention, may be made. Although it is not shown in FIG. 1 and FIG. 2, a number of ventilating holes may be located on the heat stack as envisioned by the inventor.

The heat source 18 may be any conventional pre-packaged fuel product, such as fuel canisters and candles, so long as it provides heat. The fuel products sold under the registered trademark of Sterno® brand provided by Candle Corporation of America, in Des Plaines, Ill., are preferred by the inventor as smoke is minimized; however, any compatible products may also be used.

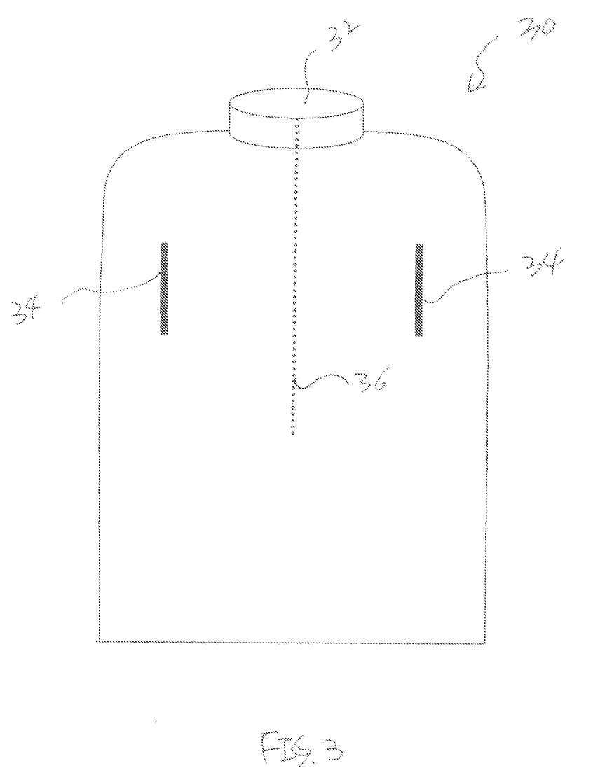

In a third preferred embodiment, the personal heating device includes both a heater and a heat suit. In FIG. 3, a heat suit, generally denoted by numeral 30, made in accordance with the present invention is disclosed. The heat suit 30 is designed as a poncho including an opening 32 in the middle for the head. Optionally, two slits 34 are cut into the front for arms and a zipper 36 in the center may included. The heat suit 30 is preferred be made of fabric with camouflage patterns, which mimics the natural surroundings, especially to maximize light reflection and to enhance blending and camouflaging of an individual relative to the natural environment. It is also envisioned by the inventor that camouflage patterns of the heat suit are subject to variance relative to the environment wherein the garment is to be used relative to snow, forests, mountains, and the like. For example, imitation bark patterns are used for hunting in woods of trees, such as oak trees, or pine trees. In addition, various colors may be used for different sports, such as the color blue for basketball teams. Since the heater is generally used outdoor in winter, polar fleece, a soft napped insulating synthetic wool fabric made from PET, is a preferred fabric for the heat suit.

To use the personal heating device of the present invention, the user may need to assemble the heater first. As shown in FIG. 2, the removable heat source 18 should be placed into the holding area 13, and then the heat stack 22 would be attached onto the base. After the heater is assembled, it can be fastened onto the ground or any other preferred place. A user wearing the heat suit places the heater on the ground underneath the heat suit, so that the heat suit encompasses both the user's body and the heater. Therefore, the heat emitted from the heater is kept under the heat suit and keeps the user warm in an outdoor environment. A suitable heat source may be able to keep the user warm for outdoor sports in winter for up to about 6 to about 10 hours.

The present invention provides a simple personal heating device which is simple, portable, lightweight and economic. The present invention is especially useful for winter outdoor recreations while it can keep the users warm.

In summary, numerous benefits have been described which result from employing any or all of the concepts and the features of the various specific embodiments of the present invention, or those that are within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

What is claimed is:

1. A heater, adapted to be used with a removable heat source, for use in an outdoor environment, comprising:
a base including a holding area and at least one peripheral wall for receiving the removable heat source;
a heat stack sized and shaped to fit over the holding area, said heat stack removably attached to the at least one peripheral wall of the base.

2. The heater of claim 1, wherein the base includes a mounting flange.

3. The heater of claim 1, wherein the heat stack includes a lining.

4. The heater of claim 1, wherein the heat stack includes a heat source securement to keep the removable heat source in place.

5. The heater of claim 1, wherein the heat stack further includes a screen secured in a suitable location.

6. A personal heating device for use in an outdoor environment, comprising:
a heater, adapted to be used with a removable heat source, including
a base including a holding area surrounded by at least one peripheral wall for receiving the removable heat source and a mounting flange attached to the bottom of the holding area; and
a heat stack removably attached to the at least one peripheral wall of the base.

7. The personal heating device of claim 6, further comprising a heat suit.

8. The personal heating device of claim 7, wherein the heat suit is a poncho including an opening in the middle for the head.

9. The personal heating device of claim 6, wherein the holding area of the base is ring-shaped.

10. The personal heating device of claim 6, further comprising a removable heat source.

11. The personal heating device of claim 6, wherein the heat stack is tubular.

12. The personal heating device of claim 6, wherein the heat stack includes a lining.

13. The personal heating device of claim 6, wherein the heat stack includes a heat source securement to keep the removable heat source in place.

14. The personal heating device of claim 6, wherein the heat stack includes a screen secured in a suitable location.

15. A personal heating device for use in an outdoor environment, comprising:
a heat suit; and
a heater, adapted to be used with a removable heat source, including
a base container for receiving a removable heat source; and
a heat stack removably attached to the base container.

16. The personal heating device of claim 15, wherein the heat suit is a poncho including an opening in the middle for the head.

17. The personal heating device of claim 15, wherein the base container of the heater further includes a mounting flange attached to the base container.

18. The personal heating device of claim 15, wherein the heat stack includes a lining.

19. The personal heating device of claim 15, wherein the heat stack includes a heat source securement to keep the removable heat source in place.

20. The personal heating device of claim 15, the heat stack includes a screen secured in a suitable location.
